(19) United States
(12) Patent Application Publication
(10) Pub. No.: US 2005/0068785 A1
(43) Pub. Date: Mar. 31, 2005

(54) Illuminating device for vehicle

(76) Inventors: Kazuo Takeda, Aichi-ken (JP); Takao Adachi, Aichi-ken (JP); Tatsuya Ohba, Aichi-ken (JP); Mitsuhiro Nawashiro, Aichi-ken (JP); Daiichiro Kawashima, Aichi-ken (JP)

Correspondence Address: POSZ & BETHARDS, PLC, 11250 ROGER BACON DRIVE, SUITE 10, RESTON, VA, 20190, US

(21) Appl. No.: 10/950,972

(22) Filed: Sep. 28, 2004

(30) Foreign Application Priority Data
Sep. 29, 2003 (JP) 2003-338535
Oct. 2, 2003 (JP) 2003-344742

(51) Int. Cl. F21V 33/00

(52) U.S. Cl. 362/506

(57) ABSTRACT

An illuminating device is installed at an outer side surface of a rear side door of a vehicle for illuminating a road surface section beside a front side door of the vehicle. The device is accommodated in a rear side molding secured to the outer side surface of the rear side door. The light source of the illuminating device radiates light along a linear optical path extending diagonally downward from a portion of the outer side surface of the rear side door in which the light source is installed to the road surface section beside the front side door. Further, the illuminating device includes a prism lens for refracting the light of the light source outwardly and away from the outer side surface of the vehicle body. This enables the device to effectively illuminate the road surface section beside the vehicle.

### BACKGROUND OF THE INVENTION

The present invention relates to illuminating devices used in vehicles for, for example, allowing a driver or passenger to enter or exit a passenger compartment easily in the dark.

Conventionally, the techniques described in Japanese Laid-Open Utility Model Publication Nos. 62-145843 and 1-158254 are known as the aforementioned illuminating devices. In the device of the publication No. 62-145843, a light introducing board having a narrow, elongated plate-like shape is disposed in a molding of a vehicle's rear side door (a rear side molding). An installing hole extends through a middle section of the light introducing board and receives four bulbs (lamps) and a reflecting mirror. Further, a light transmitting window is formed at a lower end of the rear side molding, extending in the longitudinal direction of the rear side molding. The light of the bulbs is converged and diffused by the reflecting mirror and transmitted through the light transmitting window. The bulb light thus illuminates a road surface section below the rear side door.

In the device of publication No. 1-158254, a recess is defined in a front end surface of the rear side molding of the vehicle. The opening of the recess is faced to a rear end surface of a molding of a front side door (a front side molding). The recess accommodates a bulb. A lens is fitted in the opening of the recess such that the light of the bulb is transmitted through the lens. Further, a light passage is formed in the front side molding, extending in a curved manner from the rear end surface of the front side molding to a lower end of the front side molding. Optical fibers are arranged in the light passage. The light passage includes an incident opening and a light exiting opening. The incident opening opens at the rear end surface of the front side molding, while the light exiting opening opens at the lower end of the front side molding. The openings are each covered by a transparent plate.

When the front and rear side doors are closed, the light of the bulb is transmitted through the lens and enters the light passage from the incident opening. The light is then transmitted through the optical fibers and exits the light passage through the light exiting opening, thus illuminating a road surface section below the front side door. When the front side door is open, the light radiated by the bulb is transmitted through the lens and proceeds diagonally downward and forward with respect to the vehicle, without passing through the light passage. The light thus illuminates the road surface section below the front side door.

The device of the publication No. 62-145843 illuminates the road surface section below the rear side door in which the illuminating device is installed. However, the light of the bulbs is radiated substantially vertical from the light transmitting window to the road surface. This restricts the illuminated range, regardless of the relatively large number of the bulbs. Further, the device does not illuminate a road surface section below the front side door sufficiently.

The device of the publication No. 1-158254 transmits the light of the bulb through the light passage before radiating the light toward the road surface section, when the front and rear side doors are closed. While the light passes through the light passage, the brightness of the light is reduced. Further, like the device of the other publication, the light of the bulb is radiated substantially vertical from the light exiting opening to the road surface, restricting the illuminated area. In addition, the bulb installed in the rear side molding and the light passage defined in the front side molding complicate the configuration of the illuminating device. Also, the number of constituents is relatively large.

Further, the light radiated by the aforementioned devices, which proceeds substantially vertical toward the target road surface, may be interfered by an outer side surface of the front or rear side door. This reduces the amount of the light illuminating the road surface section.

### SUMMARY OF THE INVENTION

Accordingly, it is an objective of the present invention to provide an illuminating device for vehicles capable of effectively illuminating a road surface section beside a vehicle body. It is another objective of the present invention to provide a simply configured illuminating device for vehicles.

To achieve the foregoing and other objectives and in accordance with the purpose of the present invention, the invention provides an illuminating device for a vehicle. The illuminating device is installed at an outer side surface of a vehicle body for illuminating a road surface section beside a side door of the vehicle. The illuminating device includes a light source. The light source is disposed forward or rearward with respect to the side door in the fore-and-aft direction of the vehicle. The light source radiates light along a linear optical path extending diagonally downward from the portion of the outer side surface of the vehicle body in which the light source is installed to the road surface section beside the side door.

The present invention also provides an illuminating device for a vehicle. The illuminating device is installed at an outer side surface of a vehicle body for illuminating a road surface section beside the vehicle body. The illuminating device includes a light source, and an optical member disposed below the light source. The optical member refracts the light of the light source outwardly and separately from the outer side surface of the vehicle body.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side view showing a vehicle including an illuminating device according to a first embodiment of the present invention;

FIG. 2 is a front cross-sectional view showing the illuminating device of FIG. 1;

FIG. 3 is a cross-sectional view taken along line 3-3 of FIG. 1;

FIG. 4 is a cross-sectional view taken along line 4-4 of FIG. 1;

FIG. 5 is a front cross-sectional view showing an illuminating device according to a second embodiment of the present invention;

FIG. 6 is a cross-sectional view showing an illuminating device according to a third embodiment of the present invention; and

FIG. 7 is a plan view explaining an area of the road surface illuminated by the device of FIG. 6 with respect to the vehicle including the device.

### DETAILED DESCRIPTION OF THE PREFERRED EMBODIMENTS

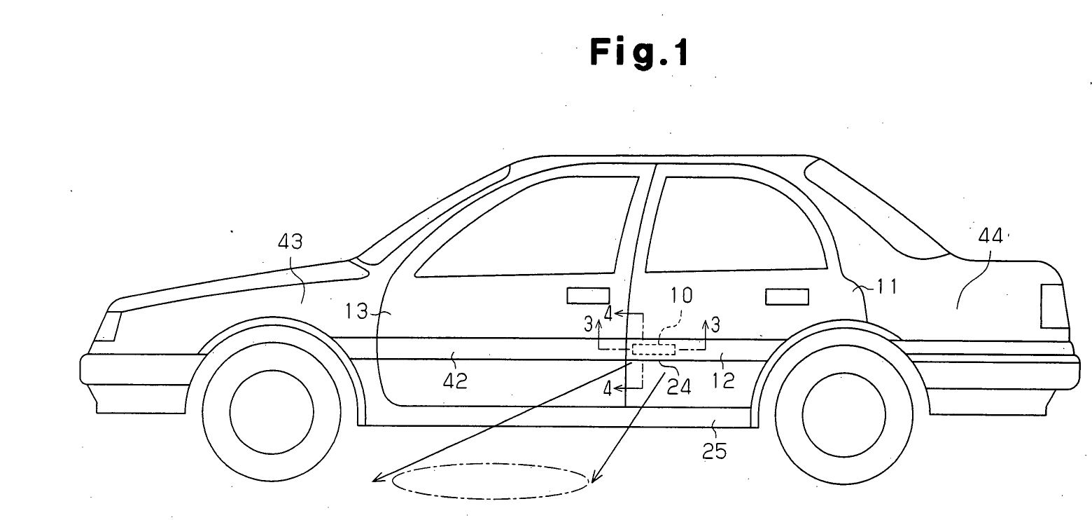

A first embodiment of the present invention will be described with reference to FIGS. 1 to 4.

As illustrated in FIG. 1, an illuminating device 10 is installed in a side door of a vehicle body, or, more specifically, attached to an outer side surface of a rear side door 11. The illuminating device 10 is installed in a band-like protection molding 12 (a rear side molding 12), which is attached to a lower section of the outer side surface of the rear side door 11. More specifically, the illuminating device 10 is located at a vertical middle section of the rear side molding 12. The device 10 radiates the light along the optical path indicated by the arrows in FIG. 1, thus illuminating a road surface section beside a front side door 13. A front side molding 42, which corresponds to the rear side molding 12, is attached to an outer side surface of the front side door 13.

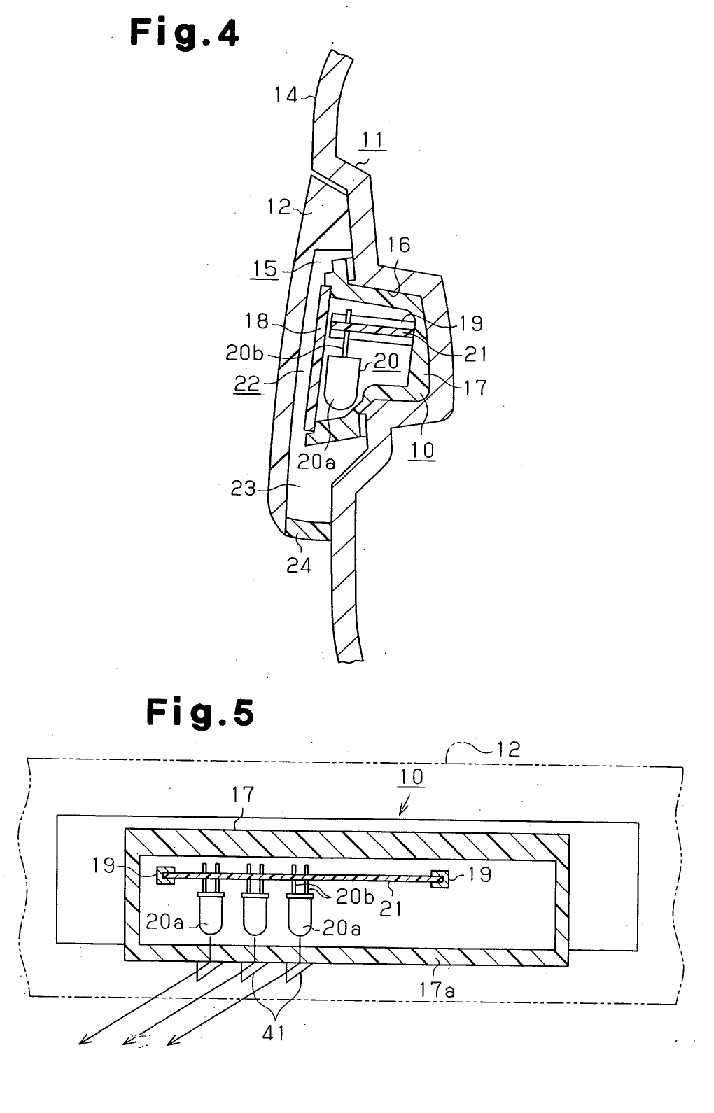

The rear side molding 12 is formed of synthetic resin, such as polypropylene or polyurethane, and extends in the fore-and-aft direction of the vehicle. As illustrated in FIG. 4, the rear side molding 12 is located slightly downward with respect to a most projected portion 14 of the outer side surface of the rear side door 11, which is projected most outwardly in the lateral direction of the vehicle. The rear side molding 12 defines an accommodating space 15 located forward with respect to a longitudinal middle portion of the rear side molding 12, or, more specifically, in the vicinity of a front end of the rear side molding 12. The accommodating space 15 is defined in a portion of the rear side molding 12 opposed to the rear side door 11 and has a square cross-sectional shape. The accommodating space 15 opens at a lower end of the rear side molding 12. An installing recess 16 is defined in an outer side surface section of the rear side door 11 opposed to the accommodating space 15. The illuminating device 10 is secured to the walls of the installing recess 16.

In other words, the illuminating device 10 is located slightly downward with respect to the most projected portion 14 of the rear side door 10 and forward with respect to the longitudinal middle portion of the rear side molding 12.

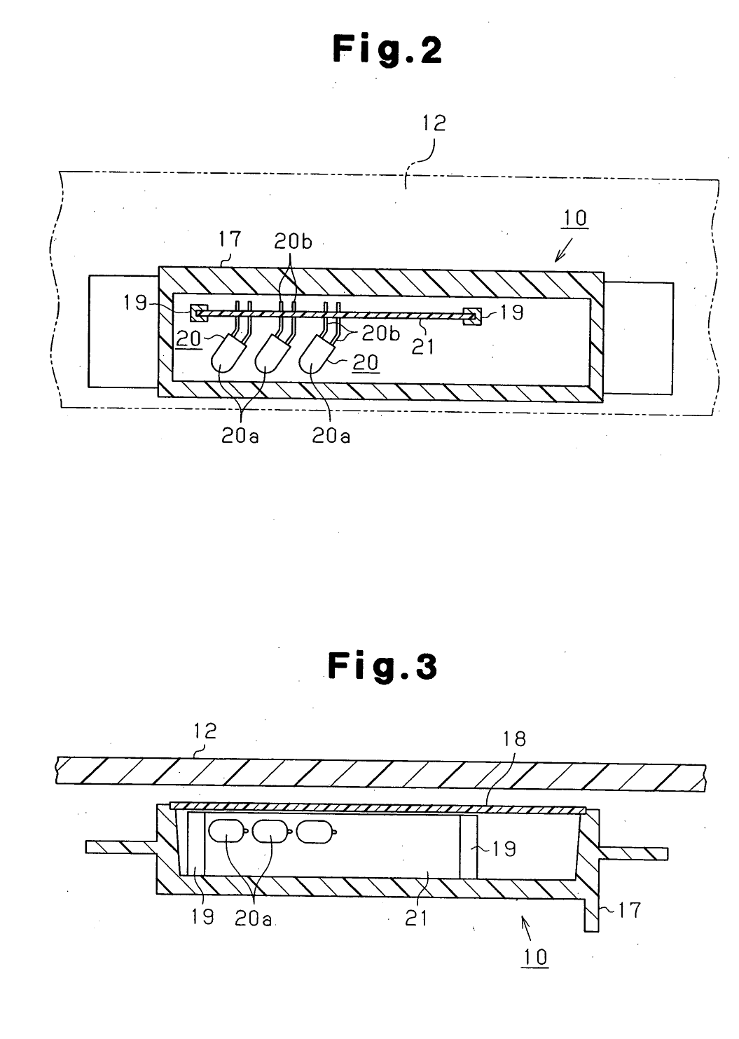

With reference to FIGS. 2 to 4, the illuminating device 10 includes a body 17, a plurality of (in this embodiment, three) light emitting diodes 20 each serving as a light source, and a lid 18. The body 17 is formed of synthetic resin such as acrylic resin and shaped like a non-lidded box. The opening of the body 17 faces outward in the lateral direction of the vehicle. The light emitting diodes 20 are accommodated in the body 17. The lid 18 closes the opening of the body 17.

A pair of support members 19 extend from an inner wall section of the body 17 toward the opening of the body 17. As illustrated in FIG. 2, each of the support members 19 supports a corresponding end of a support plate 21. The light emitting diodes 20 are secured to the support plate 21. The support plate 21 is maintained substantially horizontal. Although not illustrated, the light emitting diodes 20 are supplied with power from lines extending through the interior of the rear side door 11.

With reference to FIGS. 2 to 4, each of the light emitting diodes 20 has a light emitting portion 20a and a pair of terminal legs 20b projecting from the light emitting portion 20a. Each light emitting diode 20 is secured to the support plate 21 as suspended from the support plate 21. That is, the terminal legs 20b are secured to the support plate 21, extending downward from the support plate 21. The light emitting portion 20a of each light emitting diode 20 is disposed at the distal (lower) ends of the corresponding terminal legs 20b. Each of the light emitting portions 20a is oriented not vertically downward but diagonally downward and forward with respect to the vehicle, by bending the corresponding terminal legs 20b. In other words, each light emitting portion 20a is inclined at a predetermined angle with respect to the vertical direction, such that the light emitting portion 20a is oriented diagonally forward and downward with respect to the vehicle. Each light emitting portion 20a thus faces a road surface section beside the front side door 13, defining an optical path from the vicinity of the front end of the rear side molding 12 to the road surface section (see FIG. 1).

It is preferred that each light emitting diode 20 emits yellowish amber light. However, the light emitting diodes 20 may emit light of different colors, such that illuminating light of different types and colors is generated.

As shown in FIG. 4, a clearance 22 is defined between an outer side of the lid 18 and the opposing, inner side of the rear side molding 12. The clearance 22 functions as a shock absorbing area for minimizing an impact applied to each of the light emitting diodes 20 when, for example, the rear side molding 12 hits an obstacle such that external force acts on the outer side surface of the rear side molding 12. The accommodating space 15 includes a light transmitting space 23 located below the clearance 22 and connected to the clearance 22. The lateral dimension of the light transmitting space 23, or the interval between the inner side of the rear side molding 12 and the outer side surface of the rear side door 11, is larger than the corresponding dimension of the clearance 22.

A protecting plate 24 is attached to the lower end of the rear side molding 12, closing the opening of the accommodating space 15 located at the lower end of the rear side molding 12. The protecting plate 24 is formed of transparent synthetic resin such as polycarbonate and acrylic in a substantially rectangular plate-like shape, extending in the longitudinal direction of the rear side molding 12.

When the driver or passenger of the vehicle opens the front side door 13 for entering or exiting the passenger compartment of the vehicle in the dark, the light emitting diodes 20 are activated using a remote controller. The light thus emitted by the light emitting diodes 20 is transmitted through the light transmitting space 23 and illuminates the road surface section beside the front side door 13, as indicated by the arrows in FIG. 1.

More specifically, the light emitted by the light emitting diodes 20 is radiated from the vicinity of the front end of the rear side molding 12 to the aforementioned road surface section, diagonally forward and downward with respect to the vehicle. The light illuminating the road surface section thus covers a relatively wide range in the fore-and-aft direction of the vehicle. In other words, the light of the light emitting diodes 20 illuminates the road surface section beside the front side door 13 as projected in the fore-and-aft direction of the vehicle. As indicated by the arrows in FIG. 1, the light proceeds along a linear optical path connecting the light transmitting space 23 to the aforementioned road surface section.

The light emitted by the light emitting diodes 20 has improved directivity and is hardly diffused. This enables the light to focally illuminate a target spot, which is the road surface section beside the front side door 13. The illuminating light thus becomes sufficiently bright for permitting the driver or passenger to easily enter or exit the passenger compartment of the vehicle from the front side door 13.

Even if the front side door 13 is open, the light of the light emitting diodes 20 is allowed to proceed along the aforementioned linear optical path, without being interfered by the front side door 13. In other words, regardless of whether the front side door 13 is open or closed, the road surface section beside the front side door 13 is illuminated effectively. Further, since the light emitting diodes 20 are installed in the interior of the rear side molding 12, the light emitting diodes 20 are invisible to the driver or passenger of the vehicle.

The first embodiment has the following advantages.

The illuminating device 10 is installed at the outer side surface of the rear side door 11. The light emitted by the light source of the illuminating device 10 is radiated linearly and diagonally downward and forward with respect to the vehicle, to the road surface section beside the front side door 13. The distance of the optical path is thus minimum. In other words, the light proceeds in the exterior of the vehicle and is radiated directly to the aforementioned road surface section. This prevents the light from being attenuated before reaching the target spot, substantially eliminating the loss of the illuminating light. Accordingly, the illuminating light covers a relatively large range of the road surface section beside the front side door 13 in the fore-and-aft direction of the vehicle.

Further, as long as the illuminating device 10 is installed accurately at the predetermined location in the rear side door 11, sufficient functioning of the device 10 is ensured. The configuration of the illuminating device 10 is thus simplified.

Since the illuminating device 10 is installed in the rear side door 11, the area illuminated by the device 10 is unchanged, regardless of whether the adjacent door (the front side door 13) is open or closed. The target road surface section is thus sufficiently illuminated even when the front side door 13 is open. In other words, the illuminating device 10 illuminates the target spot effectively in a constant manner, regardless of whether or not the front side door 13 is open.

The illuminating device 10 is located slightly downward with respect to the most projected portion 14 of the rear side door 11. This prevents the light emitted by the illuminating device 10 toward the target road surface section from being interfered by the outer side surface of the vehicle body. This substantially eliminates the loss of the illuminating light, improving the illuminating efficiency of the device 10. Further, simply for preventing the light from being interfered by the vehicle body, the location of the illuminating device 10 may be changed to, for example, a position in the vicinity of the lower end of the rear side door 11 of FIG. 1, or a locker panel 25 of FIG. 1. However, this arrangement makes it highly likely for the light emitting portion of the illuminating device 10 to be contaminated by dirt or the like. In contrast, the arrangement of the illuminating device 10 of the first embodiment lowers the likeliness of such contamination. Also, in this embodiment, it is relatively easy to supply an electric current to the illuminating device 10 through the interior of the rear side door 11.

The illuminating device 10 is located forward with respect to a middle section of the rear side door 11 in the fore-and-aft direction of the vehicle. Therefore, the illuminating device 10 is allowed to radiate the light from a position relatively close to the road surface section beside the front side door 13. This makes it possible for the illuminating device 10 to illuminate the road surface section reliably and sufficiently. Also, the slanting angle of the optical path indicated by the arrows of FIG. 1 may be optimized such that the illumination covers a relatively wide range while maintaining the brightness at a relatively high level.

The light emitting diodes 20 are employed as the light source of the illuminating device 10. The light emitted by the light emitting diodes 20 has relatively high directivity and is hardly diffused. The light is thus capable of illuminating a target spot efficiently. Further, since each of the light emitting diodes 20 generates a relatively small amount of heat, thermal deformation of the body 17 and the lid 18 is suppressed. It is thus unnecessary to enlarge the body 17 for avoiding the thermal effect, making it relatively easy to minimize the illuminating device 10. Also, the power consumption of each light emitting diode 20 is relatively low and the life of the light emitting diode 20 is relatively long. This saves the power consumption of the illuminating device 10 and facilitates the maintenance of the device 10.

The protecting plate 24 closes the opening of the accommodating space 15 and isolates the accommodating space 15 from the exterior. This structure suppresses dirt deposition in the illuminating device 10 accommodated in the accommodating space 15, effectively preventing the light emitting diodes 20 from being contaminated or damaged.

FIG. 5 illustrates a second embodiment of the present invention. In the second embodiment, the terminal legs 20b of each of the light emitting diodes 20 are not bent, and the light emitting portion 20a of the light emitting diode 20 faces substantially vertically downward. However, a plurality of optical members, or prism lenses 41, are disposed at a lower wall 17a of the body 17, which is located immediately below the light emitting diodes 20. Each of the prism lenses 41 corresponds to an associated one of the light emitting diodes 20. As indicated by the arrows in FIG. 5, each prism lens 41 transmits and radiates the light of the corresponding light emitting diode 20 diagonally downward and forward. The light thus passes through the light transmitting space 23 and the protecting plate 24 (see FIG. 4), illuminating the road surface section beside the front side door 13.

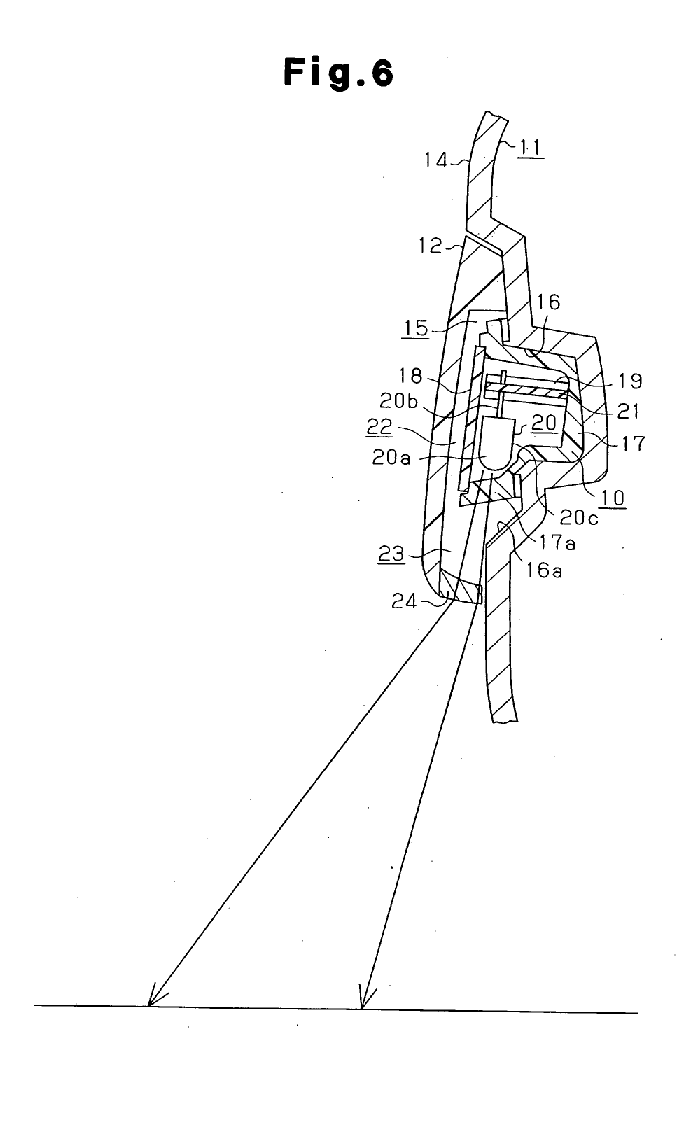

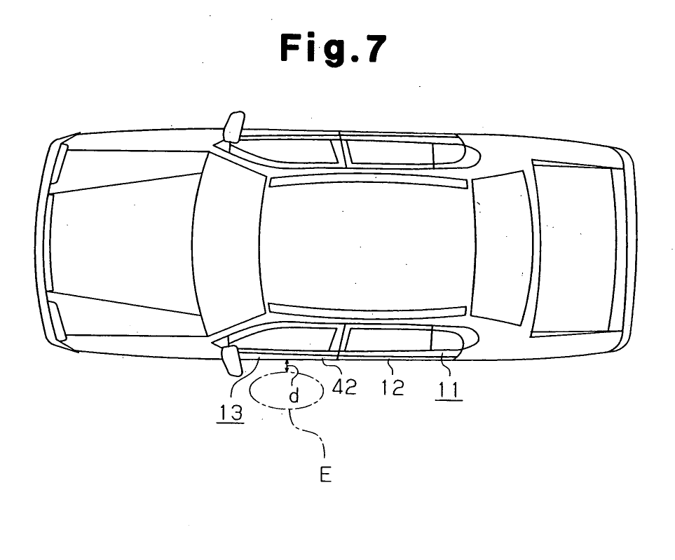

Next, a third embodiment of the present invention will be described with reference to FIGS. 6 and 7. The description will focus on the difference between the third embodiment and the first embodiment of FIGS. 1 to 4.

As illustrated in FIG. 6, each of the light emitting diodes 20 includes an inner section 20c opposed to the corresponding wall section of the installing recess 16. The inner section 20a of each light emitting diode 20 is located inward with respect to the outer side surface section of the rear side door 11 connected to the lower end 16a of the installing recess 16. In other words, each light emitting diode 20 is arranged such that a part of the light emitting portion 20a is located inward with respect to the outer side surface section of the rear side door 11 below the light emitting portion 20a. This arrangement is also applied to the first embodiment.

Further, in the second embodiment, the protecting plate 24 is formed by a prism lens serving as an optical member. The protecting plate 24, or the prism lens 24, extends from an inner side of the lower end of the rear side molding 12 to the outer side surface of the rear side door 11. Like the protecting plate 24 of the first embodiment, the prism lens 24 is formed of synthetic resin in a substantially rectangular shape, extending in the longitudinal direction of the rear side molding 12. The vertical dimension of the prism lens 24 gradually decreases from a proximal end (an outer end) to a distal end (an inner end), or inwardly with respect to the vehicle. The refraction index of the prism lens 24 thus gradually decreases from the proximal end to the distal end along the entire portion of the prism lens 24 in the longitudinal direction of the prism lens 24. That is, as compared to the light entering the vicinity of the distal end of the prism lens 24 from the light emitting diodes 20, the light entering the vicinity of the proximal end of the prism lens 24 is refracted more outwardly with respect to the vehicle. The prism lens 24 refracts the light of the light emitting diodes 20 outwardly with respect to the vehicle, or outwardly and separately from the outer side surface of the vehicle body. The light exiting the prism lens 24 thus proceeds along the linear optical path connecting the prism lens 24 to the road surface section beside the front side door 13. The road surface section illuminated by the illuminating device 10 of the third embodiment is located relatively outward with respect to the front side door 13, as compared to that of the first embodiment.

FIG. 7 illustrates an area E illuminated by the illuminating device 10 of the third embodiment. The illuminated area E is spaced outwardly with respect to the vehicle from a road surface section immediately below the front side door 13, or, more specifically, a road surface section immediately below the outermost end of the front side molding 42, in accordance with a predetermined distance d. The illuminated area E is relatively large in terms of the dimensions in the fore-and-aft and lateral directions of the vehicle.

As has been described in detail, the prism lens 24 of the third embodiment refracts the light emitted by the light emitting diodes 20 outwardly with respect to the vehicle. The light of the light emitting diodes 20 is thus separated from the outer side surface of the vehicle body, reliably preventing the light from being interfered by the vehicle body. This improves the illuminating efficiency, making it possible to effectively illuminate the target spot with a sufficient amount of light.

The area E, or the road surface section illuminated by the illuminating device 10 of the third embodiment, is spaced outwardly with respect to the vehicle from the road surface section immediately below the front side door 13, in accordance with the distance d. This makes it possible for the driver or passenger of the vehicle to enter or exit the passenger compartment further easily, as compared to the case in which the road surface section immediately below the front side door 13 is illuminated. Further, as compared to the first embodiment of FIGS. 1 to 4, the illuminated area E is enlarged in the lateral direction of the vehicle, thus enabling the illuminating device 10 of the third embodiment to illuminate the target spot further effectively.

In the third embodiment, the prism lens 24 is employed for separating the illuminated area E outwardly from the front side door 13 in accordance with the distance d. Instead of providing the prism lens 24, the light emitting portions 20a of the light emitting diodes 20 may be inclined outwardly with respect to the vehicle. However, in this case, the outward projecting amount of each light emitting diode 20 becomes relatively large. This may reduce the clearance 22 between the lid 18 and the rear side molding 12 or increase the projecting amount of the rear side molding 12. The reduced clearance 22 cannot function sufficiently as the shock absorbing area, which absorbs the impact acting on the light emitting diodes 20. The increased projecting amount of the rear side molding 12 is undesirable in terms of the aesthetic aspect of the vehicle.

In contrast, since the third embodiment employs the prism lens 24 for the aforementioned purpose, the clearance 22 is sufficiently large for effectively functioning as the shock absorbing area. Also, the projecting amount of the rear side molding 12 is minimized.

The light emitting diodes 20 are arranged in the installing recess 16 such that a part of each light emitting portion 20a is located inward with respect to the outer side surface section of the rear side door 11 below the light emitting portion 20a. This arrangement also maintains the projecting amount of the rear side molding 12 at a relatively low level. The aesthetic aspect of the vehicle is also improved.

If the light emitting diodes 20 are disposed in the installing recess 16, the light emitted by the light emitting diodes 20 may be interfered by the outer side surface of the vehicle body. However, the prism lens 24 of the third embodiment refracts the light outwardly with respect to the vehicle, preferably preventing the light from being interfered by the vehicle body. This also improves the aesthetic aspect of the vehicle and enables the illuminating device 10 to illuminate the target spot with a sufficient amount of light.

Instead of, or in addition to, the prism lens 24 at the lower end of the rear side molding 12, the lower wall 17a (see FIG. 6) of the body 17 immediately below the light emitting diodes 20 may be formed by a prism lens. This prevents the light of the light emitting diodes 20 from being interfered by the outer side surface section of the rear side door 11 connected to the lower end 16a of the installing recess 16. This increases the amount of the light illuminating the target spot.

Further, in the third embodiment, the light emitting portions 20a may be oriented substantially vertically downward, unlike the first embodiment of FIGS. 1 to 4. In this case, the illuminating device 10 illuminates a road surface section beside the rear side door 11 in which the illuminating device 10 is installed.

Also, the prism lens 24 of the third embodiment may be replaced by a diffraction grating or reflecting mirror serving as the optical member. If the reflecting mirror is employed, it is preferred that the reflecting mirror is disposed in the vicinity of the lower end 16a of the installing recess 16.

The illustrated embodiments may be modified in the following forms.

In each of the illustrated embodiments, the illuminating device 10 may be installed at the outer side surface of the front side door 13. This enables the illuminating device 10 to illuminate a road surface section beside the rear side door 11. In this case, it is preferred that the illuminating device 10 is located rearward with respect to a middle section of the front side door 13 (the front side molding 42) in the fore-and-aft direction of the vehicle.

In each of the illustrated embodiments, the illuminating device 10 may be installed in different body portions other than the side doors 11, 13, such as a front fender 43 or a rear fender 44 (see FIG. 1). If the illuminating device 10 is installed in the front fender 43, a road surface section beside the front side door 13 or the front and rear side doors 11, 13 is illuminated from a diagonally upper position of the front side of the vehicle. If the illuminating device 10 is installed in the rear fender 44, a road surface section beside the rear side door 11 or the front and rear side doors 11, 13 is illuminated from a diagonally upper position of the rear side of the vehicle.

In each of the illustrated embodiments, a plurality of illuminating device 10 may be deployed at different positions, including the side doors 11, 13 and the fenders 43, 44.

In each of the illustrated embodiments, the light emitting diodes 20 may be selectively turned on or off in cooperation with the operation of a lock device for the side door 11, 13.

In each of the illustrated embodiments, the light emitting diodes 20 may be turned on when the vehicle is reversed.

In each of the illustrated embodiments, the front and rear side doors 11, 13 are hinged doors. However, the illuminating device 10 of the present invention may be applied to a vehicle having doors slidable in the fore-and-aft direction of the vehicle.

In each of the illustrated embodiments, a different light source, such as normal light bulbs, may be employed other than the light emitting diodes 20.

The present examples and embodiments are to be considered as illustrative and not restrictive and the invention is not to be limited to the details given herein, but may be modified within the scope and equivalence of the appended claims.

1. An illuminating device for a vehicle, the illuminating device being installed at an outer side surface of a vehicle body for illuminating a road surface section beside a side door of the vehicle, the illuminating device including a light source, the light source being disposed forward or rearward with respect to the side door in the fore-and-aft direction of the vehicle, the light source radiating light along a linear optical path extending diagonally downward from the portion of the outer side surface of the vehicle body in which the light source is installed to the road surface section beside the side door.

2. The device according to claim 1, wherein the side door is a first side door, the vehicle having a second side door located forward or rearward with respect to the first side door in the fore-and-aft direction of the vehicle, the light source being disposed at an outer side surface of the second side door.

3. The device according to claim 2, wherein the first side door is a hinged door, and wherein the second side door is located rearward with respect to the first side door in the fore-and-aft direction of the vehicle.

4. The device according to claim 3, wherein the light source is located forward with respect to a middle section of the second side door in the fore-and-aft direction of the vehicle.

5. The device according to claim 3, wherein a side molding is attached to the outer side surface of the second side door and extends in the fore-and-aft direction of the vehicle, and wherein the light source is covered with the side molding and is located forward with respect to a longitudinal middle section of the side molding.

6. The device according to claim 2, wherein the outer side surface of the second side door has a most projected portion most projected outwardly in the lateral direction of the vehicle, and wherein the light source is located downward with respect to the most projected portion.

7. The device according to claim 1, wherein the side door is a hinged door, and wherein the light source is located at a section of the outer side surface of the vehicle body rearward with respect to the side door in the fore-and-aft direction of the vehicle.

8. The device according to claim 7, wherein the light source is covered with a side molding attached to the outer side surface of the vehicle body.

9. The device according to claim 8, wherein the side molding has a front end located in the vicinity of the side door, and wherein the light source is located in the vicinity of the front end of the side molding.

10. The device according to claim 1, wherein the outer side surface of the vehicle body has a most projected portion most projected outwardly in the lateral direction of the vehicle, and wherein the light source is located downward with respect to the most projected portion.

11. The device according to claim 1 further including an optical member for refracting the light of the light source toward the road surface section beside the side door.

12. The device according to claim 1 further including an optical member for refracting the light of the light source outwardly and separately from the outer side surface of the vehicle body.

13. The device according to claim 1, wherein the light source is a light emitting diode.

14. An illuminating device for a vehicle, the illuminating device being installed at an outer side surface of a vehicle body for illuminating a road surface section beside the vehicle body, the illuminating device comprising:
a light source; and
an optical member disposed below the light source, the optical member refracting the light of the light source outwardly and separately from the outer side surface of the vehicle body.

15. The device according to claim 14, wherein an installing recess is defined in the outer side surface of the vehicle body, and wherein the light source is accommodated in the installing recess such that at least a portion of the light source is located inward with respect to the outer side surface of the vehicle body below the light source.

16. The device according to claim 14, wherein the light source is covered with a side molding attached to the outer side surface of the vehicle body, and wherein the optical member is attached to a lower end of the side molding.

17. The device according to claim 14, wherein an installing recess is defined in the outer side surface of the vehicle body, and wherein a side molding is attached to the outer side surface of the vehicle body for covering the installing recess, the side molding defining an accommodating space for accommodating the light source at a position corresponding to the installing recess, the accommodating space having an opening at a lower end of the side molding, the optical member being secured to a wall of the opening.

18. The device according to claim 14, wherein the optical member includes an outer end spaced from the outer side surface of the vehicle body and an inner end relatively close to the outer side surface of the vehicle body, and wherein the refraction index of the optical member gradually decreases from the outer end to the inner end such that, as compared to the light of the light source entering the vicinity of the inner end of the optical member, the light of the light source entering the vicinity of the outer end of the optical member is refracted more outwardly with respect to the vehicle body.

19. The device according to claim 14, wherein the outer side surface of the vehicle body has a most projected portion most projected outwardly in the lateral direction of the vehicle, and wherein the light source is located downward with respect to the most projected portion.

20. The device according to claim 14, wherein the light source is a light emitting diode.
